(19) United States
(12) Patent Application Publication
(10) Pub. No.: US 2023/0161951 A1
(43) Pub. Date: May 25, 2023

(54) CONTENT EDITING METHOD AND APPARATUS, AND ELECTRONIC DEVICE

(71) Applicant: VIVO MOBILE COMMUNICATION CO., LTD., Dongguan (CN)

(72) Inventor: Xuehua CHI, Dongguan (CN)

(73) Assignee: VIVO MOBILE COMMUNICATION CO., LTD., Dongguan (CN)

(21) Appl. No.: 18/090,479

(22) Filed: Dec. 28, 2022

Related U.S. Application Data
(63) Continuation of application No. PCT/CN2021/102905, filed on Jun. 29, 2021.

(30) Foreign Application Priority Data
Jun. 30, 2020 (CN) 202010623090.5

(51) Int. Cl. G06F 40/166; G06F 3/0482; G06F 3/04847

(52) U.S. Cl. CPC G06F 40/166; G06F 3/0482; G06F 3/04847

(57) ABSTRACT

A content editing method and apparatus, and an electronic device are disclosed. The method includes: receiving a first input for a target document, where the target document includes M first documents, and M is a positive integer; and undoing, editing of first content in response to the first input, where the first content is content in a second document, the first content does not include second content, the second content is content edited in the target document for the last time, the second document is P first documents in the M first documents, and P is a positive integer less than or equal to M.

### CROSS-REFERENCE TO RELATED APPLICATIONS

This application is a continuation of International Application No. PCT/CN2021/102905, filed on Jun. 29, 2021, which claims priority to Chinese Patent Application No. 202010623090.5, filed on Jun. 30, 2020. The entire contents of each of the above-identified applications are expressly incorporated herein by reference.

### TECHNICAL FIELD

This application relates to the field of communications technologies, and specifically relates to a content editing method and apparatus, and an electronic device.

### BACKGROUND

With development of electronic technologies, functions of electronic devices are becoming more and more diverse. For example, a user may edit a document (for example, an excel document or a word document) by using an electronic device.

Currently, when the user edits a document (hereinafter referred to as a document a) by using the electronic device, if the user needs to modify edited content 1 in the document a, in one manner, the user may find the content 1 in the document a, and then directly modify the content 1; or in another manner, the user may trigger, by using a undo function of the document a, the electronic device to undo edited content to content 1 before the editing.

However, according to the foregoing method, in the foregoing one manner, when there is a large amount of edited content in the document 1, the user may not be able to quickly find the content 1. In the foregoing another manner, because the electronic device undoes editing of all other content edited after the content 1, the user needs to re-edit these pieces of content. Consequently, a speed of editing a document by the user may be relatively slow.

### SUMMARY

Embodiments of this application aim to provide a content editing method and apparatus, and an electronic device.

According to a first aspect, an embodiment of this application provides a content editing method. The method includes: receiving a first input for a target document, where the target document includes M first documents, and M is a positive integer; and undoing editing of first content in response to the first input, where the first content is content in a second document, the first content does not include second content, the second content is content edited in the target document for the last time, the second document is P first documents in the M first documents, and P is a positive integer less than or equal to M.

According to a second aspect, an embodiment of this application provides a content editing apparatus. The apparatus includes a receiving module and a undo module, where the receiving module is configured to receive a first input for a target document, where the target document includes M first documents, and M is a positive integer; and the undo module is configured to undo editing of first content in response to the first input received by the receiving module, where the first content is content in a second document, the first content does not include second content, the second content is content edited in the target document for the last time, the second document is P first documents in the M first documents, and P is a positive integer less than or equal to M.

According to a third aspect, an embodiment of this application provides an electronic device. The electronic device includes a processor, a memory, and a program or an instruction that is stored in the memory and that can be run on the processor, where when the program or the instruction is executed by the processor, the steps of the method in the first aspect are implemented.

According to a fourth aspect, an embodiment of this application provides a readable storage medium. The readable storage medium stores a program or an instruction, and when the program or the instruction is executed by a processor, the steps of the method in the first aspect are implemented.

According to a fifth aspect, an embodiment of this application provides a chip. The chip includes a processor and a communications interface, the communications interface is coupled to the processor, and the processor is configured to run a program or an instruction to implement the method in the first aspect.

### BRIEF DESCRIPTION OF DRAWINGS

FIG. 1 is a schematic diagram of a content editing method according to an embodiment of this application;

FIGS. 2A-2B are first schematic screen diagrams of application of a content editing method according to an embodiment of this application;

FIGS. 3A-3B are second schematic screen diagrams of application of a content editing method according to an embodiment of this application;

FIGS. 4A-4B are third schematic screen diagrams of application of a content editing method according to an embodiment of this application;

FIGS. 5A-5B are fourth schematic screen diagrams of application of a content editing method according to an embodiment of this application;

FIG. 6 is a fifth schematic screen diagram of application of a content editing method according to an embodiment of this application;

FIG. 7 is a schematic diagram of a content editing apparatus according to an embodiment of this application;

FIG. 8 is a schematic diagram of an electronic device according to an embodiment of this application; and

FIG. 9 is a schematic diagram of hardware of an electronic device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first,” “second,” and the like are intended to distinguish between similar objects but do not describe a specific order or sequence. It should be understood that the data used in such a way is interchangeable in proper circumstances so that the embodiments of this application can be implemented in an order other than the order illustrated or described herein. In addition, in the specification and the claims, “and/or” represents at least one of connected objects, and a character “/” generally represents an “or” relationship between associated objects.

A content editing method provided in the embodiments of this application may be applied to a scenario in which a user edits a document by using a content editing apparatus.

For example, when a user edits a document (hereinafter referred to as a document 2) by using an electronic device, the user needs to modify edited content 1 in a document a, where the content 1 is content other than content edited for the last time in the document a. In the related art, in one manner, the user may manually find the content 1 in the document a, and then directly modify the content 1. In this case, when there is a large amount of edited content in the document a, the user may not be able to quickly find the content 1, and thus it takes a long time for the user to find the content 1. In another manner, the user may trigger, by using an undo function of the document a, the electronic device to undo edited content to content 1 before the editing. In this case, because the electronic device undoes editing of all other content edited after the content 1, the user needs to re-edit these pieces of content, and thus it takes a long time for the user to re-edit the content that is unnecessarily undone. Consequently, a speed of editing a document by the user is relatively slow.

After the content editing apparatus receives a first input performed by the user for the document a (the document a includes M first documents, and M is a positive integer), the content editing apparatus may undo editing of the content 1 in response to the first input, and keep editing of other content in the document a. In this way, the content editing apparatus may undo editing of the content 1. It can be understood that, in this case, the content editing apparatus does not undo editing of content other than the content 1 in the document a. In this way, editing of content can be quickly undone, and a repeated editing operation can be avoided, thereby improving editing efficiency.

With reference to the accompanying drawings, the content editing method provided in the embodiments of this application is described in detail by using specific embodiments and application scenarios.

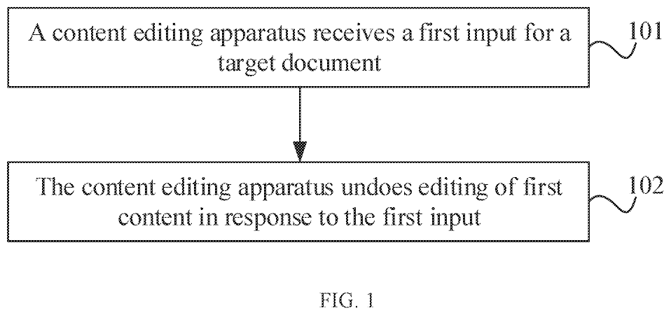

As shown in FIG. 1, an embodiment of this application provides a content editing method. The method may include the following step 101 and step 102.

Step 101: A content editing apparatus receives a first input for a target document.

The target document may include M first documents, and M is a positive integer.

For example, in this embodiment of this application, the target document may be any editable document such as a word document, an excel document (also referred to as an electronic table), or a PowerPoint document (also referred to as a slideshow). This may be determined according to an actual use requirement, and is not limited in this embodiment of this application.

For example, in this embodiment of this application, for each of the M first documents, one first document may be at least one page, at least one section, or at least one worksheet in the target document. This may be determined according to an actual use requirement, and is not limited in this embodiment of this application. A section in the target document may be obtained through separation by using a section break in the target document. For example, assuming that the target document includes one section break, the section break may separate the target document into two sections.

For example, in this embodiment of this application, the first input may be an input performed by a user for the target document by using an input device (for example, a mouse or a keyboard), or a touch input performed by the user for the target document. This may be determined according to an actual use requirement, and is not limited in this embodiment of this application.

For example, in this embodiment of this application, the first input may be an input performed by the user for a first page, and the first page may be a display page of the target document. It can be understood that content in the target document may be displayed on the first page.

Step 102: The content editing apparatus undoes editing of first content in response to the first input.

The first content may be content in a second document, the first content does not include second content, the second content may be content edited by the content editing apparatus in the target document for the last time, the second document may be P first documents in the M first documents, and P is a positive integer less than or equal to M.

For example, in this embodiment of this application, the second document may be a first document in which the first page is located, or may be a first document (that is, P=1) in which a cursor is located, or may be the M first documents, or may be a first document that meets a preset condition. This may be determined according to an actual use requirement, and is not limited in this embodiment of the present disclosure.

The preset condition may be at least one of the following: the first P first documents in the M first documents; the last P first documents in the M first documents; the first document in which the cursor is located and at least one first document after the first document in which the cursor is located in the M first documents; and P first documents before (after) the first document in which the cursor is located in the M first documents.

For example, the second document is the first document in which the first page is located. It is assumed that the target document is an electronic table, and the electronic table includes a worksheet 1 and a worksheet 2 (that is, M=2). If the user performs the first input for a display page of the worksheet 1 (that is, the first page), the second document is the worksheet 1 (P=1).

For another example, the second document is the first document in which the cursor is located. It is assumed that the target document is a word document, and the word document includes two sections (that is, M=2): a first section and a second section. If the content editing apparatus displays a display page of the first section, the cursor is located in the second section. Therefore, regardless of whether the user performs the first input for the display page of the first section or a display page of the second section, the second document is the second section (P=1).

It should be noted that the content editing method provided in this embodiment of this application is applicable not only to common editors such as a Word editor, an Excel editor, a PowerPoint editor, and a TXT editor, but also to any editor that can edit content, such as a Notepad++ editor, a Sublime text editor, an Atom editor, a VS code editor, and a UltraEdit editor.

For example, in this embodiment of this application, that the content editing apparatus undoes editing of one piece of content may include undoing typing, deletion, format modification, and the like of the content.

It should be noted that, in this embodiment of this application, when the content editing apparatus undoes editing of the first content, editing of content other than the first content in the target document is not undone.

In the content editing method provided in this embodiment of this application, the content editing apparatus may undo editing of the first content. It can be understood that, in this case, the content editing apparatus does not undo editing of content other than the first content in the target document, and therefore these pieces of content do not need to be re-edited. In this way, editing can be quickly undone, and a repeated editing operation can be avoided, thereby improving editing efficiency.

For example, in this embodiment of this application, before the content editing apparatus receives the first input performed by the user for the target document, the content editing apparatus may back up content in the M first documents in a unit of document in a process of editing the target document. In some implementations, in a first manner, the content editing apparatus may back up all content in the M first documents. In a second manner, the content editing apparatus may back up editing content in the M first documents, where the editing content may be content edited between the i^{th} backup and the (i+1)^{th} backup, and i may be a positive integer.

For example, in this embodiment of this application, in the first manner, that is, in a case that the content editing apparatus backs up all the content in the M first documents, before step 101, the content editing method provided in this embodiment of this application may further include the following step 103.

Step 103: The content editing apparatus backs up all content in the M first documents in a unit of document, and records time information of this backup.

In this embodiment of this application, time information of one backup may indicate a time at which the backup is performed.

For example, in this embodiment of this application, for each of the M first documents, (1), the content editing apparatus may back up all the content in the M first documents in a unit of document and record time information of this backup when receiving an input that the user triggers the content editing apparatus to save content in the target document, that is, the user performs one save input, and the content editing apparatus may perform a save action and a backup action. In some implementations, (2), after editing one piece of content, the content editing apparatus backs up, in a unit of document, all content in a document in which the content is located. In this case, a backup time of the content is the same as an editing time of the content. (3). The content editing apparatus may automatically back up all the content in the M first documents in a unit of document according to a preset quantity of editing times (which is determined according to an actual use requirement). This may be determined according to an actual use requirement, and is not limited in this embodiment of this application.

For example, in this embodiment of this application, for one first document, in the foregoing (1), backup content obtained through each backup may be all content in the first document after the first document is edited at least once. In the foregoing (2), backup content obtained through each backup may be content obtained after the first document is edited once.

For example, in this embodiment of this application, for each of the M first documents, after backing up all content in one first document once in a unit of document, the content editing apparatus may obtain a first tracing point record corresponding to the first document.

For example, in this embodiment of this application, the first tracing point record may include an identifier of the first document (for example, a name of the first document), backup time information, and backup content, where the backup content is all content in the first document corresponding to the first tracing point record during the backup.

It can be understood that, in this embodiment of this application, the M first documents correspond to M groups of first tracing point records, the M first documents are in a one-to-one correspondence with the M groups of first tracing point records, and a quantity of first tracing point records included in each group of first tracing point records may be determined according to an actual use requirement. In this embodiment of this application, if some first documents are not backed up, a group of first tracing point records corresponding to these first documents is empty, that is, there is no first tracing point record.

For example, in this embodiment of this application, the first tracing point record may further include a name of the user who edits the first document during the backup.

It should be noted that, in this embodiment of this application, the content editing apparatus may store, in an electronic device or a server in a unit of document, the M groups of first tracing point records obtained by backing up the M first document. This may be determined according to an actual use requirement, and is not limited in this embodiment of this application.

For example, in this embodiment of this application, the content editing apparatus may store the M groups of first tracing point records in a dictionary form, or may store the M groups of first tracing point records in any other possible form. This may be determined according to an actual use requirement, and is not limited in this embodiment of this application.

For example, in this embodiment of this application, the content editing apparatus backs up the M groups of first tracing point records in a unit of document, and each first tracing point record includes an identifier of a document. Therefore, the content editing apparatus may find, by using an identifier of each first document as a key, a group of first tracing point records (a value corresponding to the key) corresponding to each first document in the M groups of first tracing point records.

In this embodiment of this application, the content editing apparatus may back up all content in each first document of the target document in a unit of document, and record backup time information. Therefore, the content editing apparatus may find, according to an identifier of each first document and/or the backup time information, backup content corresponding to each first document, so that accuracy of searching for backup content can be improved.

For example, in this embodiment of this application, in the second manner, that is, in a case that the content editing apparatus backs up editing content in the M first documents in a unit of document, before step 101, the content editing method provided in this embodiment of this application may further include the following step 104.

Step 104: The content editing apparatus backs up editing content in the M first documents in a unit of document.

The editing content may be content edited between the it backup and the (i+1)^{th} backup, and i may be a positive integer, that is, the editing content is content edited between a previous backup and a current backup. For example, the content editing apparatus backs up editing content in one first document. If the content editing apparatus edits content a and content b in the first document after the content editing apparatus backs up editing content in the first document for the first time (that is, i=1) and before backs up editing content in the first document for the second time, when the content editing apparatus backs up the first document for the second time, the content a and the content b may be backed up in a unit of document, that is, the editing content backed up for the second time is the content a and the content b.

For example, in this embodiment of this application, for each of the M first documents, after backing up editing content in one first document once in a unit of document, the content editing apparatus may obtain a second tracing point record corresponding to the first document, where the second tracing point record may include the editing content.

For example, in this embodiment of this application, the second tracing point record may include an identifier of the first document, backup time information, location information, and editing content. The location information may indicate a region in which editing content in the second tracing point record is located in the first document. For example, the location information may be coordinate information corresponding to the editing content.

In this embodiment of this application, the M first documents may correspond to M groups of second tracing point records, the M first documents are in a one-to-one correspondence with the M groups of second tracing point records, and a quantity of second tracing point records included in each group of second tracing point records may be determined according to an actual use requirement.

For example, if the target document is an excel document, and the excel document includes a worksheet 1 and a worksheet 2, the worksheet 1 may correspond to the 1^{st} group of second tracing point records, and the 1^{st} group of second tracing point records includes three second tracing point records:
{worksheet 1: {time information 1, location information 1, editing content 1};
{time information 2, location information 2, editing content 2}; and
{time information 3, location information 3, editing content 3}}.

Correspondingly, the worksheet 2 may correspond to the 2^{nd} group of second tracing point records, and the 2^{nd} group of second tracing point records includes two second tracing point records:
{worksheet 2: {time information 4, location information 4, editing content 4}; and
{time information 5, location information 5, editing content 6}}.

For other descriptions of step 104, refer to the related descriptions of step 103. To avoid repetition, details are not described herein again.

It can be understood that in this embodiment of this application, assuming that the content editing apparatus backs up the M first documents for i+1 times in a unit of document, editing content backed up for the (i+1)^{th} time may include the foregoing second content.

In this embodiment of this application, the content editing apparatus may back up editing content in the M first documents in a unit of document. Therefore, the content editing apparatus may find, according to an identifier of each first document, at least a part of editing content corresponding to each first document, and may perform an editing undoing operation for the editing content in each first document. In this way, flexibility of editing undoing can be improved to improve editing efficiency.

With reference to the foregoing two backup manners (that is, the first manner and the second manner), the following exemplarily describes a method for undoing editing of the first content by the content editing apparatus in three possible implementations (that is, the following first possible implementation, the following second possible implementation, and the following third possible implementation).

First Possible Implementation

For example, in this embodiment of this application, in the first possible implementation, the content editing apparatus may undo editing of content in reverse order of backup times in a unit of document.

For example, in this embodiment of this application, when the second content is not content in the second document, the first content may be content that is in the second document and that has been edited for the last T times, and T is a positive integer. When the second content is content in the second document, the content editing apparatus may undo editing of other content in the second document in reverse order of backup times in a case that editing of the second content remains unchanged. Certainly, in some implementations, the content editing apparatus may first undo editing of the second content in reverse order of backup times. This may be determined according to an actual use requirement, and is not limited in this embodiment of this application. For ease of description, in the following embodiments, that the second content is not content in the second document is used as an example.

For example, in this embodiment of this application, a first control may be disposed on the display page of the target document, and the first control may be used to trigger the content editing apparatus to undo editing of content in reverse order of backup times in a unit of document. The first input may be an input performed by the user for the first control, and if the user performs the first input once, the content editing apparatus can undo content that is in the second document and that has been edited for the last T times.

For example, in this embodiment of this application, after receiving the first input performed by the user for the first control, the content editing apparatus may select the second document from the M first documents in response to the first input, obtain first backup information corresponding to the second document, determine the first content according to the first backup information, and undo editing of the first content. For example, the content editing apparatus may obtain, from the server according to an identifier of the second document, the first backup information corresponding to the second document. For descriptions of the second document, refer to the related descriptions of the second document in step 102. To avoid repetition, details are not described herein again.

For example, in this embodiment of this application, in the foregoing first manner, the content editing apparatus may determine the first content according to the first backup information by using a method A. In the foregoing second manner, the content editing apparatus may determine the first content according to the first backup information by using a method B.

The following separately describes the method A and the method B in detail.

Method A

For example, in this embodiment of this application, in the method A, the first backup information may be a group of first tracing point records corresponding to the second document. It is assumed that first tracing point records in the first backup information are arranged in reverse order of backup times. If the second content is not content in the second document, the content editing apparatus may compare content X1 with content X2, and determine content that is in the content X1 and that is different from the content X2 as the first content. The content X1 may be backup content in the 1^{st} first tracing point record in the first backup information, the content X2 may be backup content in the j^{th} first tracing point record in the first backup information, and j is a positive integer greater than or equal to 2.

It can be understood that, in this embodiment of this application, the content that is in the content X1 and that is different from the content X2 is content that is in the second document and that has been edited for the last T times, that is, the first content. For example, assuming that j=2, the backup content in the 1^{st} first tracing point record in the first backup information corresponding to the second document is “Meet at the front gate of Chunfeng Mansion at 10:00 on Wednesday morning”, and backup content in the 2^{nd} first tracing point record is “Meet at the front gate of Chunfeng Mansion on Thursday morning”, content edited in the second document forthe last time is “10:00”, that is, the first content is “10:00”.

In this embodiment of this application, when the content editing apparatus compares the two pieces of content, the content editing apparatus may compare the two pieces of content in a one-to-one correspondence of location information. For example, it is assumed that the second document is a worksheet, j=2, the following table 1 is backup content in the 1^{st} first tracing point record in the first backup information, and the following table 2 is backup content in the 2^{nd} first tracing point record in the first backup information.

TABLE 1

| | A | B | C |
|---|---|---|---|
| 1 | 80 | 78 | 60 |

TABLE 2

| | A | B | C |
|---|---|---|---|
| 1 | 80 | | 60 |

Referring to the foregoing Table 1 and the foregoing Table 2, the content editing apparatus may compare “80” in a cell A1 in Table 1 with “80” in a cell A1 in Table 2, compare “78” in a cell B1 in Table 1 with “ ” (empty content) in a cell B1 in Table 2, and compare “60” in a cell C1 in Table 1 with “60” in a cell C1 in Table 2. In this way, it can be learned that “78” in the cell B1 in Table 1 is different from “ ” in the cell B1 in Table 2, so that the content editing apparatus can determine “78” in the cell B1 in Table 1 as the first content.

For descriptions of the group of first tracing point records, refer to the related descriptions of the group of first tracing point records in the foregoing embodiment. To avoid repetition, details are not described herein again.

Method B

For example, in this embodiment of this application, in the method B, the first backup information is a group of second tracing point records corresponding to the second document, and second tracing point records in the first backup information are arranged in reverse order of backup times. If the second content is not content in the second document, the content editing apparatus may determine editing content in the first T second tracing point records in the first backup information as the first content, where T is a positive integer. If the second content is content in the second document, the content editing apparatus may determine editing content other than editing content in the 1^{st} second tracing point record in the first T+1 second tracing point records in the first backup information as the first content, where T may be a positive integer.

Certainly, in this embodiment of this application, when the second content is content in the second document, the content editing apparatus may directly determine editing content in the first T+1 second tracing point records in the first backup information.

The following exemplarily describes the method B with reference to a specific instance.

For example, the following Table 3 shows first backup information corresponding to a worksheet 1 in an excel document (the target document), including three second tracing point records, which are shown in Table 1.

TABLE 3

| Identifier of | Backup time | Location | Editing |
|---|---|---|---|
| the document | information | information | content |
| Worksheet 1 | 2020.05.20 12:55 | A3 | Type “Yes” |
| Worksheet 1 | 2020.05.20 12:57 | B7 | Type “457” |
| Worksheet 1 | 2020.05.20 13:01 | D3 | Delete “56” |

As shown in the foregoing Table 3, assuming T=1, if the user clicks a first control in a display page of the worksheet 1 once, the content editing apparatus may directly undo deletion of “56” in a cell D3. That is, the content editing apparatus may undo editing of content in the second document in reverse order of backup times.

For example, in this embodiment of this application, the user may continuously perform a plurality of clicks (that is, perform a plurality of first inputs) for the first control displayed on the first page, to trigger the content editing apparatus to successively undo editing of content in the second document in reverse order of backup times.

In this embodiment of this application, when undoing editing of content in the second document in reverse order of backup times, the content editing apparatus may keep content in another first document in the target document unchanged.

For example, it is assumed that the target document is an excel document, and the electronic document includes a worksheet 1 and a worksheet 2 (that is, M=2). The following Table 4 shows an editing record list of the user (on the target document). In some implementations, as shown in Table 4, the user types “Yes” in a cell A3 of the worksheet 1 at 12:55; the user types “457” in a cell B7 of the worksheet 1 at 12:57; the user types “Total” in a cell E30 at 12:59; the user deletes “56” in a cell D3 at 13:01; and the user types “78” in a cell D29 of the worksheet 2 at 13:02. In addition, each time an editing operation is performed, the content editing apparatus performs a backup operation once.

TABLE 4

| Editing | Backup time | Location | Editing |
|---|---|---|---|
| object | information | information | content |
| Worksheet 1 | 12:55 | A3 | Type “Yes” |
| Worksheet 1 | 12:57 | B7 | Type “457” |
| Worksheet 2 | 12:59 | E30 | Type “Total” |
| Worksheet 1 | 13:01 | D3 | Delete “56” |
| Worksheet 2 | 13:02 | D29 | Type “78” |

As shown in the foregoing Table 4, if the second document is the worksheet 1, and T=2, when the user clicks the first control on the display page of the worksheet 1 once, the content editing apparatus may directly undo deletion of “56” in the cell D3 of the worksheet 1, and undo typing of “457” in the cell B7 of the worksheet 1; and keep “78” typed in the cell D29 and “Total” typed in the cell E30 of the worksheet 2 unchanged.

For descriptions of the group of second tracing point records, refer to the related descriptions of the group of second tracing point records in the foregoing embodiment. To avoid repetition, details are not described herein again.

In this embodiment of this application, in the first possible implementation, when the user triggers the content editing apparatus to undo editing of content in reverse order of backup times in a unit of document, the content editing apparatus may distinguish between documents for performing a backoff operation, so that editing of a document other than the second document in the target document can be maintained, thereby avoiding repeated work, greatly improving efficiency of modification undoing, and improving user experience of a undo function.

For example, in this embodiment of this application, in the second possible implementation, the content editing apparatus may undo, in a unit of document, editing of content that is in the second document and that is indicated by an editing label selected by an input of the user (for example, the following fourth sub-input).

For example, in this embodiment of this application, in the second possible implementation, the first input may include a third sub-input and a fourth sub-input. Step 102 may be implemented by using the following step 102a and step 102b.

Step 102a: The content editing apparatus selects the second document from the M first documents in response to the third sub-input, and displays K editing labels corresponding to the second document.

Step 102b: The content editing apparatus selects a first editing label from the K editing labels in response to the fourth sub-input, and undoes editing of the first content.

Each of the K editing labels may be used to indicate one time of editing of the second document. The foregoing first content may be content indicated by the first editing label.

For example, in this embodiment of this application, an editing label may include location information and editing content, where the location information is in a one-to-one correspondence with the editing content. For example, an editing label may be: {A31, Type “Is” }, indicating that “Is” is typed in a cell A31; or may be {A41, Delete “May”}, indicating that “May” is deleted from a cell A41.

For example, in this embodiment of this application, an editing label may further include the identifier of the second document. For example, an editing label may be {name of the second document, location information, editing content}.

For example, in this embodiment of this application, the third sub-input may be an input performed by the user for the second control, and the second control may be displayed on the first page. The second control may be used to trigger the content editing apparatus to display editing labels corresponding to Q first documents in the M first documents, where Q is a positive integer, and Q is less than or equal to M.

For example, in this embodiment of this application, Q=P, that is, after the user performs an input for the second control, the content editing apparatus may select the Q first documents from the M first documents, determine the Q first documents as the second document, obtain second backup information corresponding to the second document, and generate the K editing labels according to the second backup information.

For example, in this embodiment of this application, in the foregoing first manner, the content editing apparatus may generate the K editing labels according to the second backup information by using a method C. In the foregoing second manner, the content editing apparatus may generate the K editing labels according to the second backup information by using a method D.

The following separately exemplarily describes the method C and the method D.

Method C

For example, in this embodiment of this application, in the method C, the second backup information may be a group of first tracing point records corresponding to the second document. It is assumed that the second backup information includes K+1 first tracing point records, and the K+1 first tracing point records are arranged in reverse order of backup times. In this case, the content editing apparatus may determine content that is in content X3 and that is different from content X4 as one piece of differential backup content, and determine backup time information corresponding to the content X3 as time information of the differential backup content. The content X3 is backup content in the s^{th} first tracing point record in the second backup information, the content X4 is backup content in the (s+1)^{th} first tracing point record in the second backup information, and s may be a positive integer greater than 1 and less than or equal to K. In this way, the content editing apparatus may obtain K pieces of differential backup content according to the K+1 first tracing point records. After the content editing apparatus determines the K pieces of differential backup content, for each piece of differential backup content in the K pieces of differential content, the content editing apparatus may determine one piece of differential backup content as editing content in one editing label, and determine location information corresponding to the one piece of differential backup content as location information in the one editing label, where the K pieces of differential backup content are in a one-to-one correspondence with the K editing labels. Therefore, the content editing apparatus may determine the K editing labels corresponding to the second document.

For example, in this embodiment of this application, for each of the K editing labels, one editing label may correspond to one piece of backup time information, and the backup time information may be time information of differential backup content corresponding to the editing label.

For other descriptions in the method C, refer to the related descriptions in the method A. To avoid repetition, details are not described herein again.

Method D

For example, in this embodiment of this application, in the method D, the second backup information may be a group of second tracing point records corresponding to the second document.

For example, in this embodiment of this application, assuming that the second backup information includes K second tracing point records, the content editing apparatus may obtain editing content and location information in each of the K second tracing point records, and generate one editing label according to the obtained editing content and location information, to obtain the K editing labels.

For example, in this embodiment of this application, in the foregoing method C and method D, the K editing labels may be arranged in reverse order of backup time information corresponding to each editing label.

For example, in this embodiment of this application, when the content editing apparatus displays the K editing labels, for each of the K editing labels, one editing label may correspond to one check box. When the user clicks one editing label (for example, the following fourth sub-input), the content editing apparatus may update the check box corresponding to the editing label from an unselected state to a selected state, so that the user can visually view the selected editing label.

For example, in this embodiment of this application, the fourth sub-input may be an input performed by the user for the first editing label in the K editing labels.

In this embodiment of this application, there may be one or more first editing labels. This may be determined according to an actual use requirement, and is not limited in this embodiment of this application.

For descriptions of the group of first tracing point records and the group of second tracing point records, refer to the related descriptions in the foregoing embodiment. To avoid repetition, details are not described herein again.

For other descriptions of step 102a and step 102b, refer to the related descriptions of step 102. To avoid repetition, details are not described herein again.

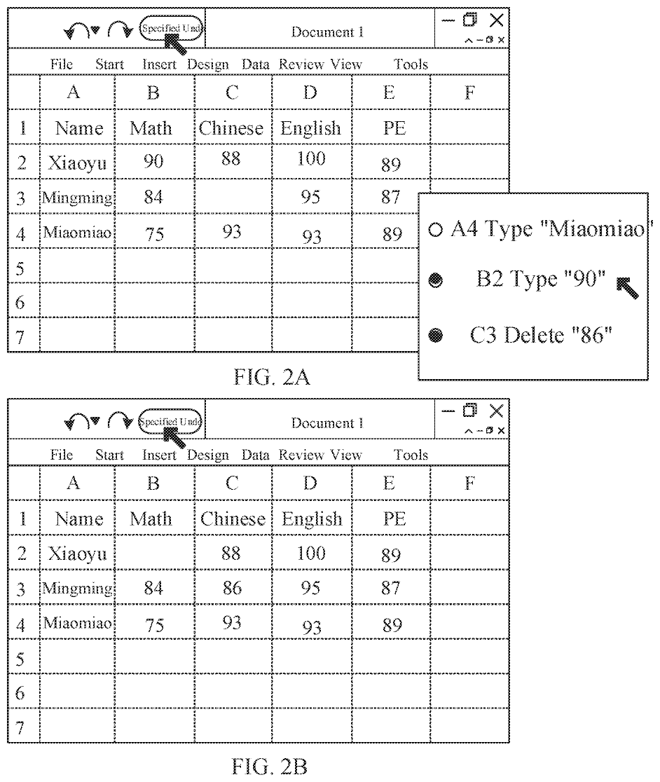

The following exemplarily describes the second possible implementation with reference to FIGS. 2A-2B.

For example, it is assumed that the target document is an excel document and may include a worksheet 1 and a worksheet 2, and the second document is the first document in which a page corresponding to the first sub-input is located. A display page of the worksheet 1 is shown in FIG. 2A. After the user clicks a “specified undo” control (that is, the second control), the content editing apparatus may select the worksheet 1 and display three editing labels (that is, K=3) corresponding to the worksheet 1. {A4 Type “Miaomiao”}, {B2 Type “90” }, and {C3 Delete “86”}. If the user clicks {B2 Type “90”} and {C3 Delete “86”}, as shown in FIG. 2B, the content editing apparatus may select {B2 Type “90”} and {C3 Delete “86” }, undo typing of “90” in B2, undo deletion of “86” in C3, and keep “Miaomiao” in A4 unchanged. It can be learned that the first content is “90” and “86,” and the second document is the worksheet 1. In this example, the user may trigger, according to an actual editing requirement of the user, the content editing apparatus to display editing labels corresponding to some first documents in the target document, so that the user can trigger the content editing apparatus to edit specified content in these first documents without undoing editing of content in a document in reverse order of backup times. Therefore, flexibility of editing undoing can be further improved in a case that editing of content in other first documents in the target document keeps unchanged, to improve editing efficiency.

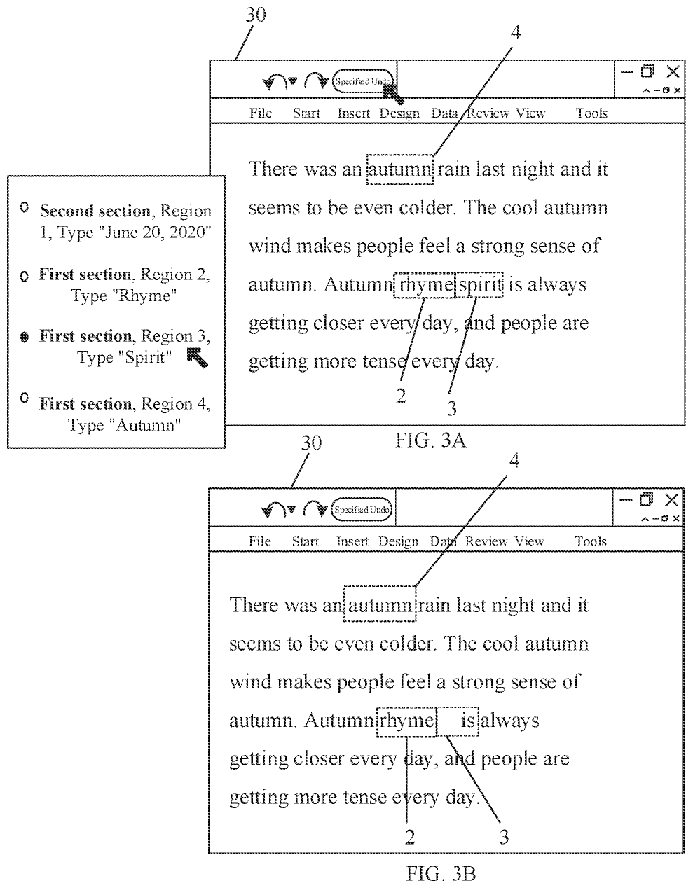

For another example, it is assumed that the target document is a word document, and the word document may include two sections: a first section and a second section. A display page 30 of the first section is shown in FIG. 3A. After the user clicks a “specified undo” control (that is, the second control), the content editing apparatus may display four editing labels corresponding to the word document (which are all editing labels corresponding to the word document). In reverse order of backup times, the four editing labels are {Second section, Region 1, Type “Jun. 20, 2020”}, {First section, Region 2, Type “Rhyme”}, {First section, Region 3, Type “Spirit”}, and {First section, Region 4, Type “Autumn”}. In this case, if the user clicks the editing label {First section, Region 3, Type “Spirit”}, as shown in FIG. 3B, the content editing apparatus may undo typing of “Spirit” in the region 3 in the first section, and keep “Jun. 20, 2020” in the region 1 in the second section, “Rhyme” in the region 2 in the first section, and “Autumn” in the region 4 in the first section unchanged. It can be learned that in the example, the first content is “Spirit” and the second document is the first section. In this example, the content editing apparatus may display an editing label corresponding to the target document. Therefore, the user may undo editing of content in the target document according to an actual use requirement of the user, so that flexibility of editing undoing can be further improved, to improve editing efficiency.

It should be noted that, in this embodiment of this application, display positions of the editing label in FIGS. 2A-2B and the editing label in FIGS. 3A-3B are merely an example. In actual implementation, these editing labels are all displayed on the display page of the target document.

In this embodiment of this application, in the second possible implementation, the user may trigger the content editing apparatus to undo editing of specified content in the second document according to an actual editing requirement of the user, and does not need to undo editing of content in the second document in reverse chronological order. Therefore, flexibility and convenience of editing undoing can be further improved in a case that editing of content in other first documents in the target document keeps unchanged, to improve editing efficiency.

For example, in this embodiment of this application, the first control and the second control may be directly displayed on the first page, or may be hidden on the first page. This may be determined according to an actual use requirement, and is not limited in this embodiment of this application.

For example, in this embodiment of this application, when the first control and the second control are hidden on the first page, in the first possible implementation and the second possible implementation, before step 101, the content editing method provided in this application may further include the following step 105 and step 106.

Step 105: The content editing apparatus receives a third input for the target document.

Step 106: The content editing apparatus displays a first control and a second control in response to the third input.

The first control may be used to trigger, in reverse order of backup times in a unit of document, the content editing apparatus to undo editing of content; the second control may be used to trigger the content editing apparatus to display editing labels corresponding to Q first documents; and the first input may include an input for the first control or the second control, Q may be a positive integer, and Q is less than or equal to M. It can be understood that in this embodiment of this application, when the user performs an input (for example, the foregoing first input) for the first control, the content editing apparatus may undo editing of content (for example, the foregoing first content) in reverse order of backup times in a unit of document.

For descriptions of the first control and the second control, refer to the related descriptions in the first possible implementation and the second possible implementation. To avoid repetition, details are not described herein again.

For example, in this embodiment of this application, the second input may be an input performed by the user on the first page. For example, the first page may include an “undo” identifier, and the second input may be an input for the “undo” identifier.

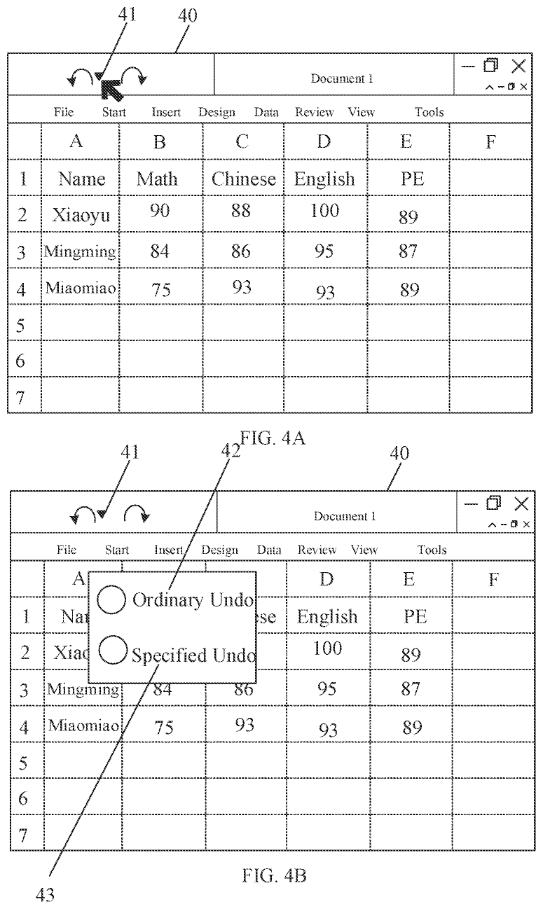

For example, a display page 40 (that is, the first page) of the target document is shown in FIG. 4A. The user may click an “undo” identifier 41 on the first page, that is, the content editing apparatus receives the second input performed by the user on the target document, and then the content editing apparatus may respond to the second input. As shown in FIG. 4B, the content editing apparatus may display a common undo control 42 (that is, the first control) and a specified undo control 43 (that is, the second control).

In this embodiment of this application, the user may trigger, through the second input, the content editing apparatus to display the first control and the second control on the first page. Therefore, the user may trigger the content editing apparatus to undo editing of content in the second document according to an actual undo requirement of the user through an input for the first control or the second control. In this way, flexibility of editing undoing can be further improved.

Third Possible Implementation

For example, in this embodiment of this application, in the third possible implementation, the first input may be an input for the first content. In some implementations, the user may perform the first input in a region in which the first content is located, trigger the content editing apparatus to select the first content, and undo editing of the first content.

For example, in this embodiment of this application, before performing the first input, the user may first trigger the content editing apparatus to highlight the region in which the first content is located, so that the user quickly locates the region in which the first content is located, and performs the first input for the first content. That the content editing apparatus highlights the region in which the first content is located is described in the following embodiment. To avoid repetition, details are not described herein again.

In this embodiment of this application, in the third possible implementation, because the content editing apparatus may highlight the region in which the first content is located, the user may intuitively view the region in which the first content is located in the second document, and may determine, according to content in a region adjacent to the region in which the first content is located, whether to undo editing of the first content, thereby improving accuracy of undoing editing of content.

The following exemplarily describes a method for highlighting the region in which the first content is located by the content editing apparatus.

For example, in this embodiment of this application, in the third possible implementation, before step 101, the content editing method provided in this embodiment of this application may further include the following step 107 and step 108.

Step 107: The content editing apparatus receives a second input for the target document.

For example, in this embodiment of this application, the second input may be an input for the first page. For other descriptions of step 107, refer to the related descriptions of step 101. To avoid repetition, details are not described herein again.

Step 108: The content editing apparatus displays, in a first manner in response to the second input, a region in which third content.

The first manner may be different from a second manner, and the second manner may be a manner of displaying a region in which fourth content is located. The third content may be content edited in the second document within first duration, and the third content and the fourth content may be different content in the second document.

For example, in this embodiment of this application, the first content may be content in the third content.

In this embodiment of this application, the first duration may be less than total duration of editing the second document. For example, assuming that the user triggers the content editing apparatus to edit the second document within a time range of [t1, t2], that is, the total duration of editing the second document is t2−t1, the first duration may be t4−t3, where t1 is less than or equal to t3, t3 is less than t4, and t4 is less than t2.

For descriptions of the second document, refer to the related descriptions of the second document in step 102. To avoid repetition, details are not described herein again.

For example, in this embodiment of this application, the first duration may be preset (which may be preset in a system or may be defined by the user), or may be determined according to the second input. This may be determined according to an actual use requirement, and is not limited in this embodiment of this application.

For example, in this embodiment of this application, for ease of description, a region in which the third content is located is referred to as a region A, and the two have the same meaning and may be interchanged. In addition, a region in which the fourth content is located is referred to as a region B, and the two have the same meaning and may be interchanged. That the content editing apparatus displays the region A in the first manner may be: the region A is displayed through highlighting, and the region B is not displayed through highlighting; or a first color is used as a background color of the region A, and a second color is used as a background color of the region B, where the first color is different from the second color; or a “restore” identifier is set in the region A, and a “restore” identifier is not set in the region B.

For example, assuming that the background color of the region B is white, the content editing apparatus may set the background color of the region A to any color that is different from white, such as red, yellow, or blue.

For another example, the content editing apparatus may set the “restore” identifier in the region A. The user may trigger, through an input for the “restore” identifier, the content editing apparatus to undo editing of content in a region indicated by the “restore” identifier. It can be understood that the “restore” identifier is not set in the region B.

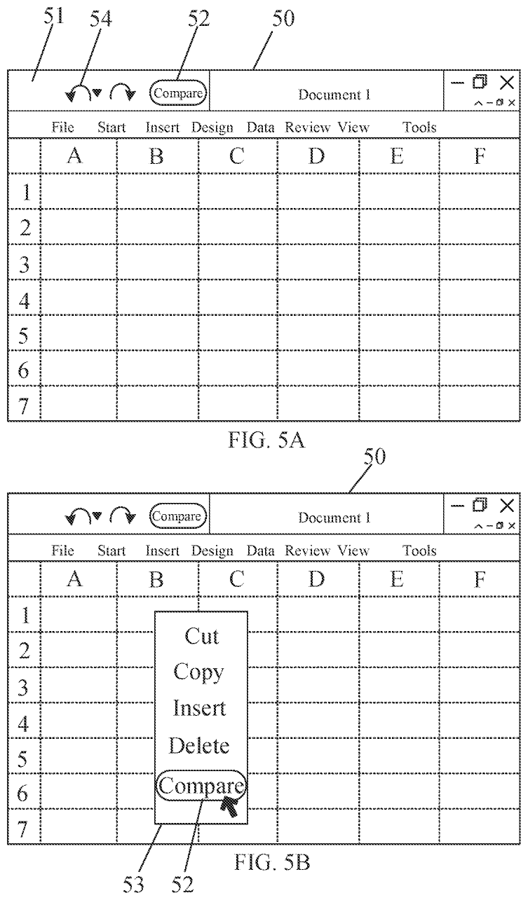

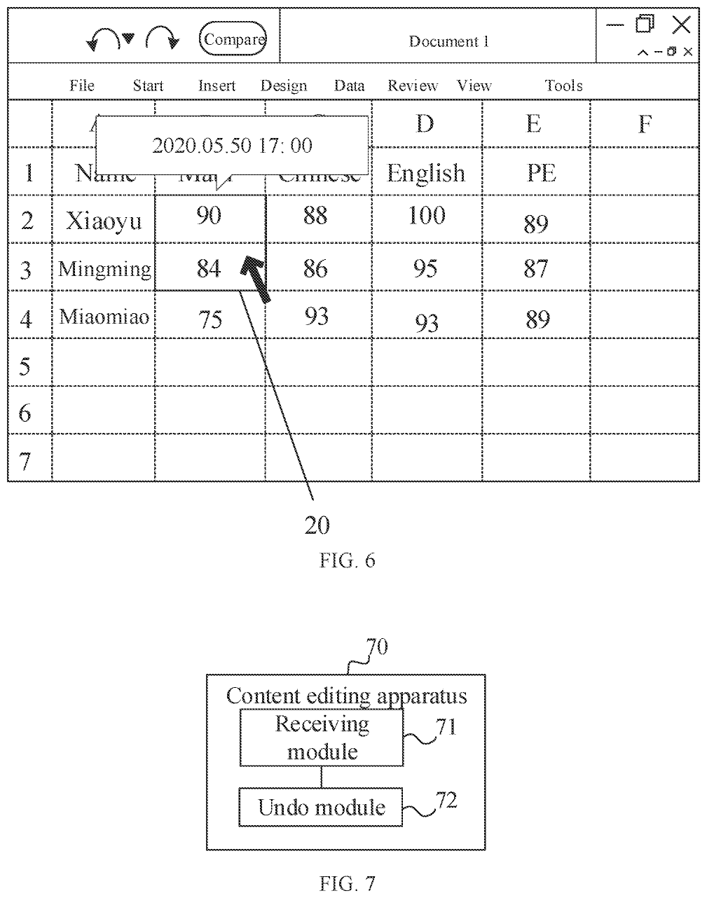

For example, in this embodiment of this application, for each piece of content in the third content, the content editing apparatus may set backup time information of the content in a region in which the content is located. When the user moves a cursor (for example, a cursor of a mouse shown in FIG. 6) to the region (for example, a filling region shown in FIG. 6), the content editing apparatus may display the backup time information of the content (for example, time information “2020.05.20 17:00” shown in FIG. 5A).

In this embodiment of this application, because the content editing apparatus may display, in different manners, the region in which the third content is located and the region in which the fourth content is located, the user can quickly locate the content edited in the second document within the first duration, so that a content search range can be narrowed and a search speed can be improved.

For example, in this embodiment of this application, when the first duration is determined according to the second input, the second input may include a first sub-input and a second sub-input. Step 108 may be implemented by using the following step 108a and step 108b.

Step 108a: The content editing apparatus selects the second document from the M first documents in response to the first sub-input, and displays N pieces of time information corresponding to the second document. Each of the N pieces of time information may be used to indicate a time at which the content editing apparatus backs up the second document once, and N may be a positive integer.

In this embodiment of this application, the first duration may be determined according to a time indicated by target time information. For example, assuming that the target time information includes: 2020.05.20 12:55, 2020.05.20 13:05, and 2020.05.20 13:10, the first duration may be a time range from 13:10 to 13:05.

For example, in this embodiment of this application, the first sub-input may be an input for a third control on the first page. The third control may be displayed on the first page, or may be hidden on the first page. This may be determined according to an actual use requirement. For example, the user performs the first sub-input by using a mouse. It is assumed that the third control is displayed on the first page. As shown in FIG. 5A, the content editing apparatus displays a first page 50, a quick access toolbar 51 on the first page 50 displays a compare control 52 (that is, the third control), and the first sub-input may be a click input performed by the user for the compare control 52 by using the mouse. For another example, the user performs an input by using a mouse. It is assumed that the third control is hidden on the first page. As shown in FIG. 5A, the content editing apparatus displays a first page 50. If the user may click the right mouse button, as shown in FIG. 5B, the content editing apparatus may display a shortcut menu 53. The shortcut menu 53 includes a compare control 52 (that is, the third control), and the first sub-input may be a click input performed by the user for the compare control 52 by using the mouse.

For example, in this embodiment of this application, before displaying the N pieces of time information corresponding to the second document, the content editing apparatus may first determine, according to the identifier of the second document, third backup information corresponding to the second document, and then determine, according to the third backup information, the N pieces of time information corresponding to the second document. The N pieces of time information may be all or a part of backup time information in the third backup information. The third backup information is described in detail in the following embodiment. To avoid repetition, details are not described herein again.

For example, in this embodiment of this application, the second sub-input may be an input performed by the user for the target time information in the N pieces of time information. The target time information may include at least one piece of time information. This may be determined according to an actual use requirement, and is not limited in this embodiment of this application.

Step 108b: In response to the second sub-input, the content editing apparatus selects target time information from the N pieces of time information, determines target editing content corresponding to the target time information as the third content, and displays, in the first manner, the region in which the third content is located.

It can be understood that, in this embodiment of this application, the target editing content may be editing content in all editing content corresponding to the second document. The target editing content is described in detail in the following embodiment. To avoid repetition, details are not described herein again.

In this embodiment of this application, after receiving the second sub-input from the user, the content editing apparatus may obtain, in response to the second sub-input, a third group of tracing point records corresponding to the target time information from the third backup information. Then, the content editing apparatus may determine, according to the third group of tracing point records, the target editing content corresponding to the target time information, and determine the target editing content as the first content.

For example, in this embodiment of this application, the third backup information is different, and a method for determining, by the content editing apparatus according to the third group of tracing point records, the target editing content corresponding to the target time information is also different. In some implementations, when the third backup information is the group of first tracing point records corresponding to the second document, that is, in the foregoing first manner, the content editing apparatus may determine the target editing content according to the third group of tracing point records by using a method E. When the third backup information is the group of second tracing point records corresponding to the second document, that is, in the foregoing second manner, the content editing apparatus may determine the target editing content according to the third group of tracing point records by using a method F.

The following separately exemplarily describes the method E and the method F.

Method E

For example, in this embodiment of this application, in the method E, the third group of tracing point records is a group of tracing point records formed by at least one first tracing point record in the group of first tracing point records corresponding to the second document. Assuming that the target time information is L pieces of time information, the third group of tracing point records may include L first tracing point records corresponding to the second document, and L may be a positive integer.

For example, in this embodiment of this application, it is assumed that the L first tracing point records are arranged in reverse order of backup times. Case 1: If L=1, content editing apparatus may determine content that is in content X5 and that is different from content X6 as the target editing content corresponding to the target time information, where the content X5 may be current content of the second document, and the content X6 may be backup content in the L first tracing point records. Case 2: If L is greater than 1, the content editing apparatus may determine content that is in content X7 and that is different from content X8 as the target editing content corresponding to the target time information, where the content X7 may be backup content in the 1^{st} first tracing point record in the L first tracing point records, and the content X8 may be backup content in the L^{th} first tracing point record in the L first tracing point records.

For example, in this embodiment of this application, in the foregoing case 1, the first duration may be a time difference between a time indicated by the target time information and current system time of the electronic device. In the foregoing case 2, the first duration may be a maximum time difference between times indicated by the target time information. For example, the target time information includes time information 1, time information 2, and time information 3. If a time indicated by the time information 1 is 12:00, a time indicated by the time information 2 is 12:05, and a time indicated by the time information 3 is 12:07, the first duration may be a time difference between 12:00 and 12:07.

For other descriptions in the method E, refer to the related descriptions in the method A in the foregoing embodiment. To avoid repetition, details are not described herein again.

Method F

For example, in this embodiment of this application, in the method F, the third group of tracing point records is a group of tracing point records formed by at least one second tracing point record in the group of second tracing point records corresponding to the second document. In some implementations, the third group of tracing point records may include a second tracing point record that is in the group of second tracing point records corresponding to the second document and whose backup time information is the target time information.

For example, in this embodiment of this application, the content editing apparatus may determine all editing content in the third group of tracing point records as the target editing content corresponding to the target time information.

In this embodiment of this application, after determining the target editing content corresponding to the target time information, the content editing apparatus may determine the target editing content as the third content, and display the third content in the first manner. For descriptions of the first manner, refer to the related descriptions of step 108. To avoid repetition, details are not described herein again.

In this embodiment of this application, the target editing content is the same as content edited in the second document within the first duration, and both are the third content.

In this embodiment of this application, because the content editing apparatus may determine the target editing content corresponding to the target time information as the third content, after the content editing apparatus displays, in a manner different from a display manner of the fourth content, the region in which the third content is located, the user can quickly locate content edited within the first duration. In this way, the user can quickly find content that is of the second document and that is edited in different time ranges, thereby improving a speed of searching for editing content.

It should be noted that the content editing method provided in the embodiments of this application may be performed by a content editing apparatus, or a control module that is in the content editing apparatus and that is configured to perform the content editing method. In the embodiments of this application, that the content editing apparatus performs the content editing method is used as an example to describe the content editing apparatus provided in the embodiments of this application.

As shown in FIG. 7, an embodiment of this application provides a content editing apparatus 70. The content editing apparatus 70 may include a receiving module 71 and an undo module 72. The receiving module 71 may be configured to receive a first input for a target document, where the target document may include M first documents, and M is a positive integer. The undo module 72 may be configured to undo editing of first content in response to the first input received by the receiving module 71, where the first content may be content in a second document, the first content may not include second content, the second content may be content edited in the target document for the last time, the second document may be P first documents in the M first documents, and P may be a positive integer less than or equal to M.

In the content editing apparatus provided in this embodiment of this application, the content editing apparatus may undo editing of the first content. It can be understood that, in this case, the content editing apparatus does not undo editing of content other than the first content in the target document, and therefore these pieces of content do not need to be re-edited. In this way, editing can be quickly undone, and a repeated editing operation can be avoided, thereby improving editing efficiency.

For example, in this embodiment of this application, the content editing apparatus may further include a first display module. The receiving module 71 may be further configured to receive a second input for the target document before receiving the first input for the target document. The first display module may be configured to display, in a first manner in response to the second input received by the receiving module 71, a region in which third content is located, where the first manner may be different from a second manner, and the second manner may be a manner of displaying a region in which fourth content is located; the third content may be content edited in the second document within first duration, the third content and the fourth content may be different content in the second document, and the first content may be content in the third content; and the first duration is less than total duration of editing the second document.

In the content editing apparatus provided in this embodiment of this application, because the content editing apparatus may display, in different manners, the region in which the third content is located and the region in which the fourth content is located, the user can quickly locate the content edited in the second document within the first duration, so that a content search range can be narrowed and a search speed can be improved.

For example, in this embodiment of this application, M may be a positive integer greater than 1, and the second input may include a first sub-input and a second sub-input. The first display module may include a first selection submodule, a first display submodule, and a determining submodule. The first selection submodule may be configured to select the second document from the M first documents in response to the first sub-input. The first display submodule may be configured to display N pieces of time information corresponding to the second document selected by the first selection submodule, where each piece of time information may be used to indicate a time at which the second document is backed up once, and N is a positive integer. The first selection submodule may be further configured to: in response to the second sub-input, select target time information from the N pieces of time information displayed by the first display submodule. The determining submodule may be configured to determine, as the third content, target editing content corresponding to the target time information selected by the first selection submodule. The first display submodule may be further configured to display, in the first manner, the region in which the third content determined by the determining submodule is located.

In the content editing apparatus provided in this embodiment of this application, because the content editing apparatus may determine the target editing content corresponding to the target time information as the third content, after the content editing apparatus displays, in a manner different from a display manner of the fourth content, the region in which the third content is located, the user can quickly locate content edited within the first duration. In this way, the user can quickly find content that is of the second document and that is edited in different time ranges, thereby improving a speed of searching for editing content.

For example, in this embodiment of this application, the first input may include a third sub-input and a fourth sub-input. The undo module 72 may include a second selection submodule, a second display submodule, and an undo submodule. The second selection submodule may be configured to select the second document from the M first documents in response to the third sub-input. The second display submodule may be configured to display K editing labels corresponding to the second document selected by the second selection submodule, where each editing label may be used to indicate one time of editing of the second document, and K is a positive integer. The second selection submodule may be further configured to: in response to the fourth sub-input, select a first editing label from the K editing labels displayed by the display submodule. The undo submodule may be configured to undo editing of the first content selected by the second selection submodule, where the first content may be content indicated by the first editing label.

In this embodiment of this application, the content editing apparatus may undo editing of specified content in the second document according to an actual use requirement of the user, and does not need to undo editing of content in the second document in reverse chronological order. Therefore, flexibility and convenience of editing undoing can be further improved in a case that editing of content in other first documents in the target document keeps unchanged.

For example, in this embodiment of this application, the content editing apparatus may include a backup module. The backup module may be configured to back up editing content in the M first documents in a unit of document before the receiving module 71 receives the first input for the target document, where the editing content may be content edited between the i^{th} backup and the (i+1)^{th} backup, and i may be a positive integer.

In the content editing apparatus provided in this embodiment of this application, the content editing apparatus may back up editing content in the M first documents in a unit of document. Therefore, the content editing apparatus may find, according to an identifier of each first document, at least a part of editing content corresponding to each first document, and may perform an editing undoing operation for the editing content in each first document. In this way, flexibility of editing undoing can be improved.

For example, in this embodiment of this application, the content editing apparatus may further include a second display module. The receiving module 71 may be further configured to receive a third input for the target document before receiving the first input for the target document. The second display module may be configured to display a first control and a second control in response to the third input received by the receiving module 71.

The first control may be used to trigger, in reverse order of backup times in a unit of document, the content editing apparatus to undo editing of content; the second control may be used to trigger the content editing apparatus to display editing labels corresponding to Q first documents; and the first input may include an input for the first control or the second control, Q may be a positive integer, and Q is less than or equal to M.

In the content editing apparatus provided in this embodiment of this application, the content editing apparatus may display the first control and the second control on a first page through the second input of the user. Therefore, the content editing apparatus may undo editing of content in the second document according to an actual undo requirement of the user and in different undoing manners, thereby further improving flexibility of editing undoing.

The content editing apparatus in this embodiment of this application may be an electronic device, or may be a component, an integrated circuit, or a chip in the electronic device. The electronic device may be a mobile electronic device, or may be a non-mobile electronic device. For example, the mobile electronic device may be a mobile phone, a tablet computer, a laptop computer, a palmtop computer, an in-vehicle terminal, a wearable device, an Ultra-Mobile Personal Computer (UMPC), a netbook, or a Personal Digital Assistant (PDA). The non-mobile electronic device may be a server, a Personal Computer (PC), a television, an automated teller machine, or a self-service machine. This is not limited in this embodiment of this application.

The content editing apparatus in this embodiment of this application may be an apparatus with an operating system. The operating system may be an Android operating system, an iOS operating system, or another possible operating system. This is not limited in the embodiments of this application.

The content editing apparatus provided in this embodiment of this application can implement the processes implemented in the content editing method in the method embodiments in FIG. 1 to FIG. 6. To avoid repetition, details are not described herein again.

For example, as shown in FIG. 8, an embodiment of this application further provides an electronic device 200, including a processor 201, a memory 202, and a program or an instruction that is stored in the memory 202 and that can be run on the processor 201. When the program or the instruction is executed by the processor 201, the processes of the foregoing content editing method embodiment are implemented and a same technical effect can be achieved. To avoid repetition, details are not described herein again.

It should be noted that the electronic device in this embodiment of this application includes the foregoing mobile electronic device and the foregoing non-mobile electronic device.

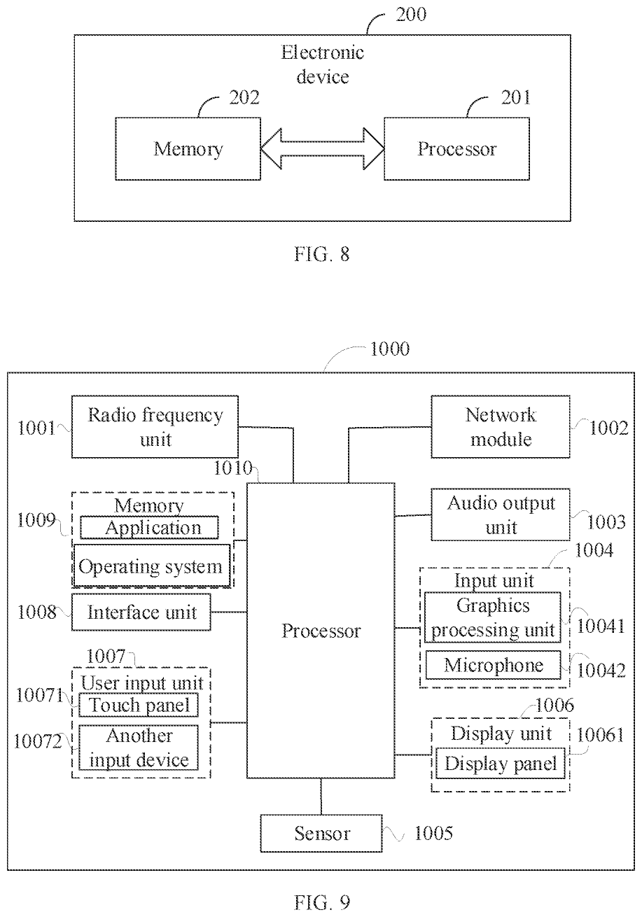

FIG. 9 is a schematic structural diagram of hardware of an electronic device according to an embodiment of this application.

An electronic device 1000 includes but is not limited to components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the electronic device 1000 may further include a power supply (such as a battery) that supplies power to each component. The power supply may be logically connected to the processor 1010 by using a power supply management system, to implement functions such as charging and discharging management, and power consumption management by using the power supply management system. The structure of the electronic device shown in FIG. 9 does not constitute a limitation on the electronic device. The electronic device may include components more or fewer than those shown in the diagram, a combination of some components, or different component arrangements. Details are not described wherein.

The user input unit 1007 may be configured to receive a first input for a target document, where the target document may include M first documents, and M is a positive integer. The processor 1010 may be configured to undo editing of first content in response to the first input received by the user input unit 1007, where the first content may be content in a second document, the first content may not include second content, the second content may be content edited in the target document for the last time, the second document may be P first documents in the M first documents, and P may be a positive integer less than or equal to M.

In the electronic device provided in this embodiment of this application, the electronic device may undo editing of the first content. It can be understood that, in this case, the electronic device does not undo editing of content other than the first content in the target document, and therefore these pieces of content do not need to be re-edited. In this way, editing can be quickly undone, and a repeated editing operation can be avoided, thereby improving editing efficiency.

For example, in this embodiment of this application, the user input unit 1007 may be further configured to receive a second input for the target document before receiving the first input for the target document. The display unit 1006 may be configured to display, in a first manner in response to the second input received by the user input unit 1007, a region in which third content is located, where the first manner may be different from a second manner, and the second manner may be a manner of displaying a region in which fourth content is located; the third content may be content edited in the second document within first duration, the third content and the fourth content may be different content in the second document, and the first content may be content in the third content; and the first duration is less than total duration of editing the second document.

In the electronic device provided in this embodiment of this application, because the electronic device may display, in different manners, the region in which the third content is located and the region in which the fourth content is located, the user can quickly locate the content edited in the second document within the first duration, so that a content search range can be narrowed and a search speed can be improved.

For example, in this embodiment of this application, M may be a positive integer greater than 1, and the second input may include a first sub-input and a second sub-input. The processor 1010 may be further configured to select the second document from the M first documents in response to the first sub-input. The display unit 1006 may be configured to display N pieces of time information corresponding to the second document selected by the processor 1010, where each piece of time information may be used to indicate a time at which the second document is backed up once, and N is a positive integer. The processor 1010 may be further configured to: in response to the second sub-input, select target time information from the N pieces of time information displayed by the display unit 1006. The processor 1010 may be further configured to determine target editing content corresponding to the target time information as the third content. The display unit 1006 may be further configured to display, in the first manner, the region in which the third content determined by the processor 1010 is located.

In the electronic device provided in this embodiment of this application, because the electronic device may determine the target editing content corresponding to the target time information as the third content, after the electronic device displays, in a manner different from a display manner of the fourth content, the region in which the third content is located, the user can quickly locate content edited within the first duration. In this way, the user can quickly find content that is of the second document and that is edited in different time ranges, thereby improving a speed of searching for editing content.

For example, in this embodiment of this application, the first input may include a third sub-input and a fourth sub-input. The processor 1010 may be further configured to select the second document from the M first documents in response to the third sub-input. The display unit 1006 may be further configured to display K editing labels corresponding to the second document selected by the processor 1010, where each editing label may be used to indicate one time of editing of the second document, and K is a positive integer. The processor 1010 may be further configured to: select, in response to the fourth sub-input, a first editing label from the K editing labels displayed by the display unit 1006; and undo editing of the first content, where the first content may be content indicated by the first editing label.

In this embodiment of this application, the electronic device may undo editing of specified content in the second document according to an actual use requirement of the user, and does not need to undo editing of content in the second document in reverse chronological order. Therefore, flexibility and convenience of editing undoing can be further improved in a case that editing of content of other first documents in the target document keeps unchanged.

For example, in this embodiment of this application, the processor 1010 may be further configured to back up editing content in the M first documents in a unit of document before the user input unit 1007 receives the first input for the target document, where the editing content may be content edited between the i^{th} backup and the (i+1)^{th} backup, and i is a positive integer.

In the electronic device provided in this embodiment of this application, the electronic device may back up editing content in the M first documents in a unit of document. Therefore, the electronic device may find, according to an identifier of each first document, at least a part of editing content corresponding to each first document, and may perform an editing undoing operation on the editing content in each first document. In this way, flexibility of editing undoing can be improved.

For example, in this embodiment of this application, the user input unit 1007 may be further configured to receive a third input for the target document before receiving the first input for the target document. The display unit 1006 may be further configured to display a first control and a second control in response to the third input received by the user input unit 1007. The first control may be used to trigger, in reverse order of backup times in a unit of document, the electronic device to undo editing of content; the second control may be used to trigger the electronic device to display editing labels corresponding to Q first documents; and the first input may include an input for the first control or the second control, Q may be a positive integer, and Q is less than or equal to M.

In the electronic device provided in this embodiment of this application, the electronic device may display the first control and the second control on a first page through the second input of the user. Therefore, the electronic device may undo editing of content in the second document according to an actual undo requirement of the user and in different undoing manners, thereby further improving flexibility of editing undoing.

It should be understood that, in this embodiment of this application, the input unit 1004 may include a Graphics Processing Unit (GPU) 10041 and a microphone 10042, and the graphics processing unit 10041 processes image data of a still picture or a video obtained by an image capture apparatus (such as a camera) in a video capture mode or an image capture mode. The display unit 1006 may include a display panel 10061. For example, the display panel 10061 may be configured in a form such as a liquid crystal display or an organic light-emitting diode. The user input unit 1007 includes a touch panel 10071 and another input device 10072. The touch panel 10071 is also referred to as a touchscreen. The touch panel 10071 may include two parts: a touch detection apparatus and a touch controller. The another input device 10072 may include but is not limited to a physical keyboard, a functional button (such as a volume control button or a power on/off button), a trackball, a mouse, and a joystick. Details are not described herein. The memory 1009 may be configured to store a software program and various data, including but not limited to an application and an operating system. An application processor and a modem processor may be integrated into the processor 1010, the application processor mainly processes an operating system, a user interface, an application, and the like, and the modem processor mainly processes wireless communication. It can be understood that, in some implementations, the modem processor may not be integrated into the processor 1010. An embodiment of this application further provides a readable storage medium. The readable storage medium stores a program or an instruction, and when the program or the instruction is executed by a processor, the processes of the foregoing content editing method embodiment are implemented, and a same technical effect can be achieved. To avoid repetition, details are not described herein again. The processor is the processor in the electronic device in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communications interface, the communications interface is coupled to the processor, and the processor is configured to run a program or an instruction to implement the processes of the foregoing content editing method embodiment, and a same technical effect can be achieved. To avoid repetition, details are not described herein again. It should be understood that the chip mentioned in this embodiment of this application may also be referred to as a system-level chip, a system chip, a chip system, or an on-chip system chip.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “including a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may understand that the method in the foregoing embodiment may be implemented by software in addition to a necessary universal hardware platform or by hardware only. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A content editing method, comprising:
receiving a first input for a target document, wherein the target document comprises M first documents, and M is a positive integer; and
undoing editing of first content in response to the first input, wherein the first content is content in a second document, the first content does not comprise second content, the second content is content edited in the target document for the last time, the second document is P first documents in the M first documents, and P is a positive integer less than or equal to M.

2. The method according to claim 1, wherein before the receiving a first input for a target document, the method further comprises:
receiving a second input for the target document; and
displaying, in a first manner in response to the second input, a region in which third content is located, wherein the first manner is different from a second manner, and the second manner is a manner of displaying a region in which fourth content is located, and
wherein the third content is content edited in the second document within first duration, the third content and the fourth content are different content in the second document, the first content is content in the third content, and the first duration is less than total duration of editing the second document.

3. The method according to claim 2, wherein M is a positive integer greater than 1, and the second input comprises a first sub-input and a second sub-input, and
wherein the displaying, in a first manner in response to the second input, a region in which third content is located comprises:
in response to the first sub-input, selecting the second document from the M first documents, and displaying N pieces of time information corresponding to the second document, wherein each piece of time information is used to indicate a time at which the second document is backed up once, and N is a positive integer; and
in response to the second sub-input, selecting target time information from the N pieces of time information, determining target editing content corresponding to the target time information as the third content, and displaying, in the first manner, the region in which the third content is located.

4. The method according to claim 1, wherein the first input comprises a third sub-input and a fourth sub-input, and
wherein the undoing editing of first content in response to the first input comprises:
in response to the third sub-input, selecting the second document from the M first documents, and displaying K editing labels corresponding to the second document, wherein each editing label is used to indicate one time of editing of the second document, and K is a positive integer; and
in response to the fourth sub-input, selecting a first editing label from the K editing labels, and undoing editing of the first content, wherein the first content is content indicated by the first editing label.

5. The method according to claim 1, wherein before the receiving a first input for a target document, the method further comprises:
backing up editing content in the M first documents in a unit of document, wherein the editing content is content edited between the i^{th} backup and the (i+1)^{th} backup, and i is a positive integer.

6. The method according to claim 1, wherein before the receiving a first input for a target document, the method further comprises:
backing up all content in the M first documents in a unit of document; and
recording backup time information.

7. The method according to claim 1, wherein before the receiving a first input for a target document, the method further comprises:
receiving a third input for the target document; and
displaying a first control and a second control in response to the third input, wherein the first control is used to trigger, in reverse order of backup times in a unit of document, to undo editing of content, the second control is used to trigger display of editing labels corresponding to Q first documents, and the first input comprises an input for the first control or the second control, wherein Q is a positive integer, and Q is less than or equal to M.

8. An electronic device, comprising:
a memory storing computer-readable instructions; and
a processor coupled to the memory and configured to execute the computer-readable instructions, wherein the computer-readable instructions, when executed by the processor, cause the processor to perform operations comprising:
receiving a first input for a target document, wherein the target document comprises M first documents, and M is a positive integer; and
undoing editing of first content in response to the first input, wherein the first content is content in a second document, the first content does not comprise second content, the second content is content edited in the target document for the last time, the second document is P first documents in the M first documents, and P is a positive integer less than or equal to M.

9. The electronic device according to claim 8, wherein before the receiving a first input for a target document, the operations further comprise:
receiving a second input for the target document; and
displaying, in a first manner in response to the second input, a region in which third content is located, wherein the first manner is different from a second manner, and the second manner is a manner of displaying a region in which fourth content is located, and
wherein the third content is content edited in the second document within first duration, the third content and the fourth content are different content in the second document, the first content is content in the third content, and the first duration is less than total duration of editing the second document.

10. The electronic device according to claim 9, wherein M is a positive integer greater than 1, and the second input comprises a first sub-input and a second sub-input, and
wherein the displaying, in a first manner in response to the second input, a region in which third content is located comprises:
in response to the first sub-input, selecting the second document from the M first documents, and displaying N pieces of time information corresponding to the second document, wherein each piece of time information is used to indicate a time at which the second document is backed up once, and N is a positive integer; and
in response to the second sub-input, selecting target time information from the N pieces of time information, determining target editing content corresponding to the target time information as the third content, and displaying, in the first manner, the region in which the third content is located.

11. The electronic device according to claim 8, wherein the first input comprises a third sub-input and a fourth sub-input, and
wherein the undoing editing of first content in response to the first input comprises:
in response to the third sub-input, selecting the second document from the M first documents, and displaying K editing labels corresponding to the second document, wherein each editing label is used to indicate one time of editing of the second document, and K is a positive integer; and
in response to the fourth sub-input, selecting a first editing label from the K editing labels, and undoing editing of the first content, wherein the first content is content indicated by the first editing label.

12. The electronic device according to claim 8, wherein before the receiving a first input for a target document, the operations further comprise:
backing up editing content in the M first documents in a unit of document, wherein the editing content is content edited between the i^{th} backup and the (i+1)^{th} backup, and i is a positive integer.

13. The electronic device according to claim 8, wherein before the receiving a first input for a target document, the operations further comprise:
backing up all content in the M first documents in a unit of document; and
recording backup time information.

14. The electronic device according to claim 8, wherein before the receiving a first input for a target document, the operations further comprise:
receiving a third input for the target document; and
displaying a first control and a second control in response to the third input, wherein the first control is used to trigger, in reverse order of backup times in a unit of document, to undo editing of content, the second control is used to trigger display of editing labels corresponding to Q first documents, and the first input comprises an input for the first control or the second control, wherein Q is a positive integer, and Q is less than or equal to M.

15. A non-transitory computer-readable medium storing instructions that, when executed by a processor, cause the processor to perform operations comprising:
receiving a first input for a target document, wherein the target document comprises M first documents, and M is a positive integer; and
undoing editing of first content in response to the first input, wherein the first content is content in a second document, the first content does not comprise second content, the second content is content edited in the target document for the last time, the second document is P first documents in the M first documents, and P is a positive integer less than or equal to M.

16. The non-transitory computer-readable medium according to claim 15, wherein before the receiving a first input for a target document, the operations further comprise:
receiving a second input for the target document; and
displaying, in a first manner in response to the second input, a region in which third content is located, wherein the first manner is different from a second manner, and the second manner is a manner of displaying a region in which fourth content is located, and
wherein the third content is content edited in the second document within first duration, the third content and the fourth content are different content in the second document, the first content is content in the third content, and the first duration is less than total duration of editing the second document.

17. The non-transitory computer-readable medium according to claim 16, wherein M is a positive integer greater than 1, and the second input comprises a first sub-input and a second sub-input, and
wherein the displaying, in a first manner in response to the second input, a region in which third content is located comprises:
in response to the first sub-input, selecting the second document from the M first documents, and displaying N pieces of time information corresponding to the second document, wherein each piece of time information is used to indicate a time at which the second document is backed up once, and N is a positive integer; and
in response to the second sub-input, selecting target time information from the N pieces of time information, determining target editing content corresponding to the target time information as the third content, and displaying, in the first manner, the region in which the third content is located.

18. The non-transitory computer-readable medium according to claim 15, wherein the first input comprises a third sub-input and a fourth sub-input, and
wherein the undoing editing of first content in response to the first input comprises:
in response to the third sub-input, selecting the second document from the M first documents, and displaying K editing labels corresponding to the second document, wherein each editing label is used to indicate one time of editing of the second document, and K is a positive integer; and
in response to the fourth sub-input, selecting a first editing label from the K editing labels, and undoing editing of the first content, wherein the first content is content indicated by the first editing label.

19. The non-transitory computer-readable medium according to claim 15, wherein before the receiving a first input for a target document, the operations further comprise:
backing up editing content in the M first documents in a unit of document, wherein the editing content is content edited between the i^{th} backup and the (i+1)^{th} backup, and i is a positive integer.

20. The non-transitory computer-readable medium according to claim 15, wherein before the receiving a first input for a target document, the operations further comprise:
receiving a third input for the target document; and
displaying a first control and a second control in response to the third input, wherein the first control is used to trigger, in reverse order of backup times in a unit of document, to undo editing of content, the second control is used to trigger display of editing labels corresponding to Q first documents, and the first input comprises an input for the first control or the second control, wherein Q is a positive integer, and Q is less than or equal to M.
